(19) United States
(12) Patent Application Publication
(10) Pub. No.: US 2014/0172459 A1
(43) Pub. Date: Jun. 19, 2014

(54) CLINICAL SUPPORT SYSTEM AND METHOD

(71) Applicants: Jan Johannes Gerardus De Vries, Eindhoven (NL); Aleksandra Tesanovic, Eindhoven (NL); Gijs Geleijnse, Geldrop (NL)

(72) Inventors: Jan Johannes Gerardus De Vries, Eindhoven (NL); Aleksandra Tesanovic, Eindhoven (NL); Gijs Geleijnse, Geldrop (NL)

(73) Assignee: KONINKLIJKE PHILIPS ELECTRONICS N.V., EINDHOVEN (NL)

(21) Appl. No.: 14/105,633

(22) Filed: Dec. 13, 2013

(30) Foreign Application Priority Data
Dec. 14, 2012 (EP) 12197257.4

(51) Int. Cl. G06F 19/00

(52) U.S. Cl. CPC G06F 19/3431
USPC 705/3

(57) ABSTRACT

The present invention relates to a clinical support system and a corresponding clinical support method. The system comprises a processor and a computer-readable storage medium, wherein the computer-readable storage medium contains instructions for execution by the processor, wherein the instructions cause the processor to perform the steps of obtaining a health score curve over time of a patient, for whom a recommendation for a moment of discharge from a medical facility shall be provided, obtaining a reference curve to the health score curve, wherein said reference curve indicates a patient stabilization over time, computing a difference between the health score curve and said reference curve, and computing a recommended moment of discharge from the medical facility based on the difference between said health score curve and said reference curve. Further, the present invention relates to a computer-readable non-transitory storage medium and a computer program.

### FIELD OF THE INVENTION

The present invention relates to a clinical support system comprising a processor and a computer-readable storage medium, wherein the computer-readable storage medium contains instructions for execution by the processor. Further, the present invention relates to a clinical support method, a computer-readable non-transitory storage medium and a computer program.

### BACKGROUND OF THE INVENTION

In hospitals and other medical facilities the determination of the optimal point in time for discharging a patient from the medical facility is crucial. Too long hospitalizations are inconvenient for the patient, unnecessarily increase treatment expenses and occupy resources that may be required for another patient. However, too short hospitalizations increase the probability of a short-term readmission. A readmission shortly after discharge puts a large burden on the patient and also increases the overall health care costs. Therefore, it is important to determine the right moment for discharging the patient from the medical facility.

Models that predict the length of stay (LOS) from patient data gathered at admission, have been presented in literature, for example in A. Kerr et al., “Does admission grip strength predict length of stay in hospitalised older patients?”, Age Ageing (January 2006) 35(1): 82-84; R. E. Jiménez et al., “Observed-predicted length of stay for an acute psychiatric department, as an indicator of inpatient care inefficiencies”, Retrospective case-series study, BMC Health Sery Res. 2004; Gregory Mak et al., “Physicians' Ability to Predict Hospital Length of Stay for Patients Admitted to the Hospital from the Emergency Department”, Emergency Medicine International 2012.

However, the existing models are characterized by a low accuracy. Even though hospitals often assign patients with a similar disease to the same ward, within these wards the LOS of individual patients usually is quite diverse. In particular for patients with chronic heart failure it is extraordinary difficult to predict the LOS in advance.

U.S. Pat. No. 8,100,829 B2 discloses a system and method for providing a health score for a patient. The health score indicates the current health status of a patient. Health scores at different points in time can be displayed as a health score plot or a health score curve over time. The determination of the moment of discharge is left to the clinician who can compare the individual patient's health score curve with a standard health score curve from patients with a similar disease. However, no decision support is provided to the physician. U.S. Pat. No. 8,100,829 B2 is incorporated herein by reference.

A health score of the patient is also provided by current products of the applicant, such as the Philips IntelliVue Guardian patient monitors, wherein several vital sign measurements are combined into a single score indicating the patient's health.

In order to facilitate work for medical staff and to improve the quality of service, there is a growing need for evidence-based decision support for determining the optimal moment of discharge.

### SUMMARY OF THE INVENTION

It is an object of the present invention to provide a clinical support system and a clinical support method that better assist a clinician to determine the right moment for discharging a patient from a medical facility.

In a first aspect of the present invention a clinical support system is presented that comprises a processor and a computer-readable storage medium, wherein the computer-readable storage medium contains instructions for execution by the processor, wherein the instructions cause the processor to perform the steps of:

obtaining a health score curve over time of a patient, for whom a recommendation for a moment of discharge from a medical facility shall be provided,

obtaining a reference curve to the health score curve, wherein said reference curve indicates a patient's stabilization over time,

computing a difference between the health score curve and said reference curve, and

computing a recommended moment of discharge from the medical facility based on the difference between said health score curve and said reference curve.

In a further aspect of the present invention a corresponding clinical support method is presented.

In yet other aspects of the present invention, there are provided a computer program which comprises program code means for causing a computer to perform the steps of the clinical support method when said computer program is carried out on a computer, and a computer-readable non-transitory storage medium containing instructions for execution by a processor, wherein the instructions cause the processor to perform the steps of the claimed clinical support method.

Preferred embodiments of the invention are defined in the dependent claims. It shall be understood that the claimed method, computer program, and computer-readable non-transitory storage medium have similar and/or identical preferred embodiments as the claimed system and as defined in the dependent claims.

Compared to existing models, the clinical support system according to the present invention does not only rely on data gathered at admission. Instead, the health score curve over time of a patient is evaluated which significantly improves the accuracy of the recommended moment of discharge. By computing the difference between the health score curve and the reference curve that indicates the patient's stabilization over time, any deviation from the reference curve can be closely tracked and directly used to adjust the recommended moment of discharge from the medical facility.

Thus, an evidence-based decision support is provided by the present invention to assist the clinician to make educated decisions about discharging the patient at the optimal moment in time.

In one aspect, the invention provides for a clinical support system. A clinical support system as used herein encompasses an automated system which facilitates the determination of a moment of discharge from a medical facility. The clinical support system comprises a processor and a computer-readable store medium.

A ‘computer-readable storage medium’ as used herein encompasses any storage medium which may store instructions which are executable by a processor of a computing device. The computer-readable storage medium may be referred to as a computer-readable non-transitory storage medium. The computer-readable storage medium may also be referred to as a tangible computer readable medium. In some embodiments, a computer-readable storage medium may also be able to store data which is able to be accessed by the processor of the computing device. An example of a computer-readable storage medium include, but are not limited to: a floppy disk, a magnetic hard disk drive, a solid state hard disk, flash memory, a USB thumb drive, Random Access Memory (RAM) memory, Read Only Memory (ROM) memory, an optical disk, a magneto-optical disk, and the register file of the processor. Examples of optical disks include Compact Disks (CD) and Digital Versatile Disks (DVD), for example CD-ROM, CD-RW, CD-R, DVD-ROM, DVD-RW, DVD-R or Blu-ray disks. The term computer readable-storage medium also refers to various types of recording media capable of being accessed by the computer device via a network or communication link. For example a data may be retrieved over a modem, over the internet, or over a local area network.

A ‘processor’ as used herein encompasses an electronic component which is able to execute a program or machine executable instruction. References to the computing device comprising ‘a processor’ should be interpreted as possibly containing more than one processor. The term computing device should also be interpreted to possibly refer to a collection or network of computing devices each comprising a processor. Many programs have their instructions performed by multiple processors that may be within the same computing device or which may even distributed across multiple computing devices.

In a preferred embodiment of the clinical support system according to the present invention, the period of time until the recommended moment of discharge scales with said difference between the health score curve and the reference curve. The reference curve is indicative of the patient's stabilization over time. For example, if the health score curve deviates from the reference curve and the difference between health score curve and reference curve is large, the recommended moment of discharge will be at a later point in time. Correspondingly, if the difference is small, the patient can be discharged earlier.

In an embodiment, the instructions further cause the processor to compute said difference between the health score curve and the reference curve by computing an area between the health score curve and the reference curve. In one embodiment, the area is computed by integrating over the absolute value of the difference between the health score curve and the reference curve. Optionally, the area between the health score curve and the reference curve, or generally the difference between the health score curve and the reference curve, can be divided by the measurement time, i.e., the length of the health score curve that is taken into account for computing the difference. This can be seen as a normalization of the difference between health score curve and reference curve to have a time independent difference.

In another embodiment, the instructions further cause the processor to obtain the reference curve by fitting a curve to the health score curve. The reference curve indicates patient stabilization over time and, in particular, in the future. The process of recovery from a disease depends on the individual patient and can be quite diverse. Even though a patient has a similar condition, for example indicated by a same or similar DRG/ICD-10 grouping, same age, gender and further similarities, the process of recovery can be significantly different. The inventors have identified that, in many cases, it is not sufficient to compare the health score curve with a standard recovery curve even if that standard recovery curve is disease-specific. Instead, a reference curve has to be obtained for the individual patient, which reference curve indicates the patient stabilization over time. This can be achieved by fitting a curve as a reference curve to the health score curve of the individual patient. The fitting can be done for the entire health score curve or for a section or sub-section of the health score curve. The term ‘fitting’, as used in the context of this application, is to be understood in a broad sense of matching a curve to the health score curve. For example, a curve of the shape

$$f ( t ) = {x}_{0} + {x}_{1} ( 1 - exp ( - \frac{t - {x}_{2}}{{x}_{3}} ) ) ,$$

where t is the time and x₀ . . . x₃ are fitting parameters, is fitted to a section of the health score curve by a least-squares optimization as a fitting criterion. However, any other suitable fitting criterion can be employed. Alternatively, a curve of the shape

$$f ( t ) = \frac{{x}_{4} ( t - {x}_{5} )}{1 + {x}_{6} ( t - {x}_{5} )} ,$$

with fitting parameters x₄ . . . x₆ is used. A further alternative curve shape is given by f(t)=x₇ log(x₈(t−x₉)), with fitting parameters x₇ . . . x₉. The curve shape that is used as a basis for fitting the curve to the individual patient can be disease specific. For example, the overall curve shape is derived empirically from a population of patients, such as an average curve of health-score development over all successfully discharged patients from the past. Further examples include, but are not limited to a −1/x curve or a sigmoid function. In general, any curve shape that indicates a patient stabilization over time, in particular a curve with that saturates or converges to an end value, is suitable.

In yet another embodiment, the instructions further cause the processor to identify a section of the health score curve and/or a section of the reference curve for which the difference between the health score curve and the reference curve is computed. Instead of evaluating a difference of the curves for the entire time, it is possible to select sections or segments of the curves and to compute a difference thereof. For example, only the last couple of days are taken into account. In other words, not the entire health score curve is used to compute the recommended moment of discharge but only a section thereof.

Optionally, a section comprises sub-sections. For example, only those sub-sections are taken into account for calculating the difference between health score curve and reference curve, wherein the health score of the reference curve is higher than the health score of the patient to form a first section. A second section can be formed from sub-sections, wherein the health score of the patient is higher than the health score of the reference curve. The recommended moment of discharge can be computed based on the first section and/or the second section and/or a weighted combination of first and second section wherein first and second section are weighted with weighting factors.

There are several options to identify the curve sections to be used for computing the recommended moment of discharge. Some non-limiting examples are presented in the following.

In an embodiment, the instructions further cause to processor to perform the steps of finding local maxima of the health score curve, finding local minima of the health score curve adjacent to the local maxima, and finding a pair of local maximum and local minimum of the health score curve with an amplitude above a threshold, wherein said section of the health score curve and/or said section of the reference curve start at the local maximum and/or local minimum of the pair of local maximum and local minimum. This embodiment evaluates at least one oscillatory movement, i.e. a movement with minimum and maximum, to determine where the evaluation of the health score curve and reference curve should start.

Alternatively, according to an embodiment the instructions further cause the processor to perform the steps of computing a difference curve by subtracting a correction curve from the health score curve, and finding zero-crossings of the difference curve, wherein said section of the health score curve and/or said section of the reference curve starts at a zero-crossing of the difference curve. For example, the difference curve can be a straight line through a first point and a second point on the health score curve and/or the reference curve. Thus, the correction curve can correct for a base line shift or a slope. However, the correction curve is not limited to a straight line but any curve that is appropriate can be used for correction. The recommended moment of discharge can be computed, for example, based on the curve section of the health score curve starting from the last zero-crossing of the difference curve to the end of the recorded health score curve.

In a further embodiment, pattern matching can be used to identify the relevant section of the health score and/or of the reference curve. For pattern matching, a sliding window can be used wherein the health score curve within the window is multiplied with an expected reference curve, e.g., a saturation curve, for each position of a sliding window and the result of the multiplication is evaluated. The resulting signal will peak whenever the original curve is shaped like the reference curve. Such a peak, for example the last peak in the resulting signal, can be used as the starting point for the section to be identified. Essentially, the sliding window approach provides a correlation of the health score curve with the expected reference curve.

In a further embodiment, the starting point for the section to be evaluated can be determined by analyzing the gradient of the health score curve. The starting point is set when the curve reaches a predefined threshold value, for example when the slope of the curve reaches a predefined value. Preferably, all of these methods look for the last bit of the health score curve, since the patient's condition should stabilize towards the end of the patient's stay.

In an advantageous embodiment of the clinical support system according to the present invention, the instructions further cause the processor to calculate a moment of saturation, when the reference curve has reached a saturation threshold, which saturation threshold indicates a moment in time when the reference curve has saturated enough for patient discharge. In general, patient discharge requires a stable condition of the patient. Hence, not only the absolute value of the health score but also information about how constant the health score is over time indicate whether it is safe to discharge a patient or not. The moment of saturation defines the predicted moment of discharge which indicates when the patient could be discharged under the assumption that the health score curve of the patient corresponds to the reference curve. However, if the health score curve deviates from the reference curve, the patient should be discharged at a later point in time. The period of time between the predicted moment of discharge and the recommended moment of discharge scales with the difference between health score curve and reference curve.

According to another aspect of this embodiment the instructions further cause the processor to compute the recommended moment of discharge from the medical facility further based on said predicted moment of discharge and/or based on an anticipated health score at said predicted moment of discharge. In other words, in addition to evaluating the difference between health score curve and reference curve, the predicted moment of discharge and/or the anticipated health score at said predicted moment of discharge can be taken into account when calculating the recommended moment of discharge.

In another embodiment, the instructions further cause the processor to perform the steps of obtaining samples of patient data over time, wherein the patient data is descriptive of the patient, and calculating health scores based on said samples of patient data. Hence, the system calculates the health scores based on the raw samples of patient data. When provided with a plurality of samples of patient data over time, a health score curve can be determined.

According to another aspect of this embodiment, the instructions further cause the processor to use a clinical risk model and/or clinical status model for computing said health scores. The patient's status can be determined for example from vital sign measurements, laboratory values, and the psychological and physiological state. In addition to the patient's status, a health score can comprise the patient risk. For example a predicted adverse event in the future already lowers the health score of the patient today. For example, the term “health score” refers to the composite score based upon patient data and risks.

In a further aspect of the present invention a clinical support system is presented that comprises means for obtaining a health score curve over time of a patient for whom a recommendation for a moment of discharge from a medical facility shall be provided, means for obtaining a reference curve to the health score curve, wherein said reference curve indicates a patient's stabilization over time, means for computing the difference between the health score curve and said reference curve, and means for computing a recommended moment of discharge from the medical facility based on the difference between said health score curve and said reference curve.

### BRIEF DESCRIPTION OF THE DRAWINGS

These and other embodiments of the invention will be apparent from and elucidated with reference to the embodiment(s) described hereinafter. In the following drawings

FIG. 1 shows a graph of a health score curve over time;

FIG. 2 shows a schematic diagram of a first embodiment of a clinical support system;

FIG. 3 shows a flow chart of a first embodiment of the proposed clinical support method;

FIG. 4A shows a graph of a health score curve and a reference curve according to a first example;

FIG. 4B shows a graph of the health score curve and a reference curve according to a second example;

FIGS. 5A-C illustrate a selection of a section of a health score curve;

FIG. 6 shows the frame work that the current invention can be used in.

### DETAILED DESCRIPTION OF THE INVENTION

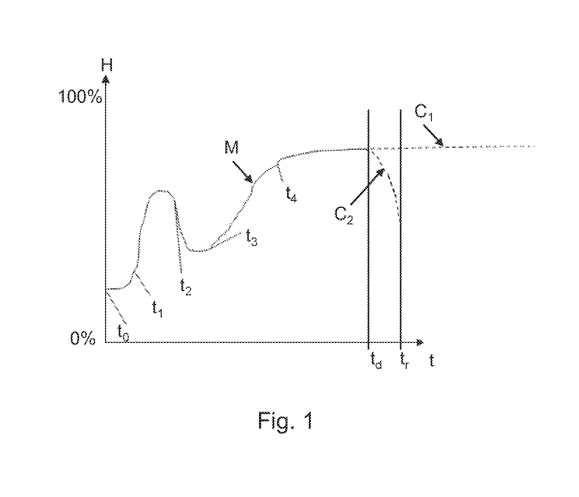

FIG. 1 shows a graph of the health score curve over time. The health score curve is essentially a measure for the dynamics of the patient's status over a hospitalization period. The horizontal axis denotes the time t, whereas the vertical axis denotes the current health score H of the patient.

At time t=0, the patient enters the hospital severely ill and the treatment starts. At time t=t₁ the treatment shows first effects and the health score starts to increase. The patient responds well to the treatment. However, at time t=t₂ the condition of the patient gets worse, for example, due to an adverse event. An adverse event can be any event that has negative impact on the patient's health. The health score continues to decrease until an adjustment treatment has positive effect at time t=t₃. Around t=t₄, the health score curve flattens and starts to saturate. This moment in time indicates when the condition of the patient starts to stabilize. The patient is approaching discharge. The problem that is addressed in the current invention is how to actually determine the optimal moment for discharge. In the given example, the patient is discharged at time t=t_{d}. If this is the right moment for discharge cannot be conclusively answered for all patients in all conditions but depends on the individual patient.

After the moment of discharge, FIG. 1 shows two possible future health score curves C₁ and C₂. As can be seen from the graph, the health score curve C₁ remains at a stable level after discharge. However, for C₁, the health score curve has already been at a stable level even before discharging the patient from hospital. Hence, the patient with curve C₁ could have already been discharged shortly after t=t₄. An earlier discharge and thus a shorter length of stay (LOS) reduces the overall treatment cost. Furthermore, the patient comfort is increased since he is not required to stay at the hospital for such a long time.

The second example curve C₂, illustrates a scenario when the patient is discharged too early. Shortly after discharge at time t=t_{d}, the health score of the patient decreases significantly. Ultimately, the patient has to be readmitted to the hospital at time t=tᵣ. In this example, the overall treatment cost significantly increases since the treatment has to be started again from a low health score level instead of keeping the patient a little longer to wait for his condition to stabilize to a robust level.

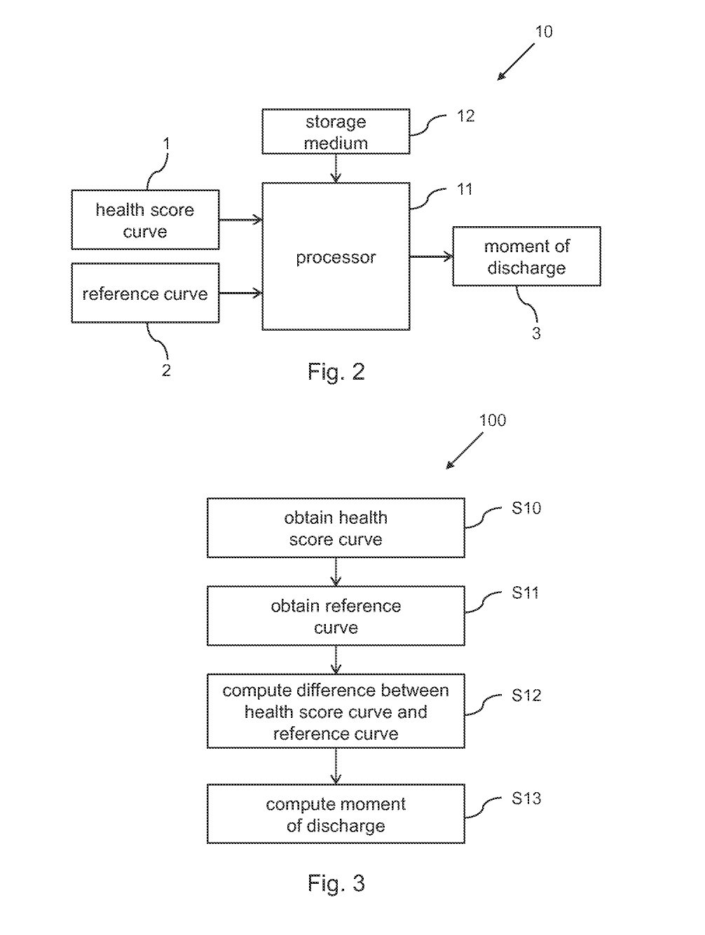

FIG. 2 shows a schematic diagram of the first embodiment of a clinical support system 10 according to the present invention. It comprises a processor 11 and a computer-readable storage medium 12. The computer-readable storage medium 12 contains instructions for execution by the processor 11. These instructions cause the processor 11 to perform the steps of a clinical support method 100 as illustrated in the flow chart shown in FIG. 3.

In a first step S10 a health score curve 1 over time of the patient, for whom a recommendation for a moment of discharge 3 from a medical facility shall be provided, is obtained. In a second step S11 a reference curve 2 to the health score curve 1 is obtained, wherein said reference curve 2 indicates a patient's stabilization over time. In a third step S12 a difference between the health score curve 1 and the reference curve 2 is computed from said obtained health score curve 1 and said obtained reference curve 2. In a fourth step S13 a recommended moment of discharge 3 from the medical facility is computed based on the difference between said health score curve 1 and said reference curve 2.

The health score curve 1 is a curve that indicates the transient behavior of a health score of the patient over time as illustrated in FIG. 1. The reference curve 2 in turn indicates how the health score of the patient should improve over time. The reference curve 2 also makes a prediction about the future stabilization of the patient. The patient stabilization prediction takes both the patient status and optionally also risk estimations as an input.

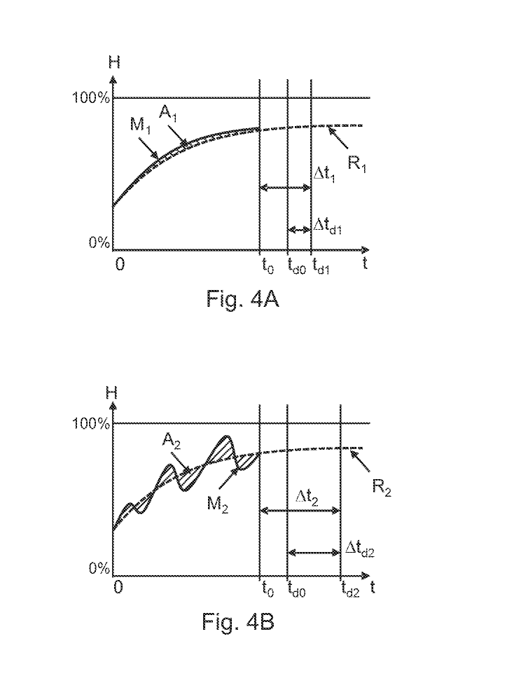

FIG. 4A shows a graph of a health score curve and a reference curve according to a first example. The horizontal axis denotes the time t, whereas the vertical axis denotes the health score H. The actually measured health scores based on patient data are indicated by the health score curve M₁. The reference curve to the health score curve that indicates the patient's stabilization over time is denoted by R₁. The quantity t₀ indicates the current date and time. Obviously, the measured health score curve M₁ is only available until t₀. For each data point of the health score curve M₁ there can be a point of the reference curve R₁. For each pair of points from M₁ and R₁ a difference between M₁ and R₁ can be calculated. The summation of these differences gives the area A₁ between the health score curve M₁ and the reference curve R₁. The moment of saturation, that indicates a moment in time when the reference curve has saturated enough for presumably safe patient discharge, is denoted by the estimated moment of discharge t_{d0}. This value essentially gives the earliest possible moment of discharge for an ideal recovery of the patient.

In the example in FIG. 4A, the difference between M₁ and R₁ is small. This is indicated by a small area A₁. In other words, the health score curve M₁ and the reference curve R₁ match well. The patient condition improves as predicted. In consequence, the recommended moment of discharge t_{d1} can be shortly after t_{d0}. The time difference Δt₁ denotes the time difference between the current date and time t₀ and the recommended moment of discharge from t_{d1} from the medical facility, Δt₁=t_{d1}−t₀. The time difference Δt_{d1} denotes the time difference between the predicted earliest possible moment of discharge t_{d0} and the recommended moment of discharge from t_{d1} from the medical facility, Δt_{d1}=t_{d1}−t_{d0}.

FIG. 4B shows a second example of a health score curve M₂ and a reference curve R₂. In this example the health score curve M₂ deviates significantly from the reference curve R₂. Phases of exceptionally well recovery with increasing health score are followed by a decreasing health score. The difference between health score curve and reference curves is again indicated by an area A₂. A large area indicates that the patient condition does not stabilize as predicted. In consequence, the instructions cause the processor to compute the recommended moment of discharge t_{d2} as a later point in time. The time difference between the recommended moment of discharge t_{d2} and the current date in time t_{d0} is given by Δt₂>Δt₁.

Alternatively, the area A₂ does not include the entire area between health score curve and reference curve but only limited sections. For example the area only comprises sections of the curve where the health score curve lies below the reference curve. In this example only a negative deviation from the reference curve is considered for calculating the recommended moment of discharge. Further alternately, the sections where the health score curve lies above the reference curve can also be considered in the calculation of the recommended moment of discharge since these sections indicate that the patient is doing better than expected and may reduce the time Δt₂ until the recommended moment of discharge t_{d2}.

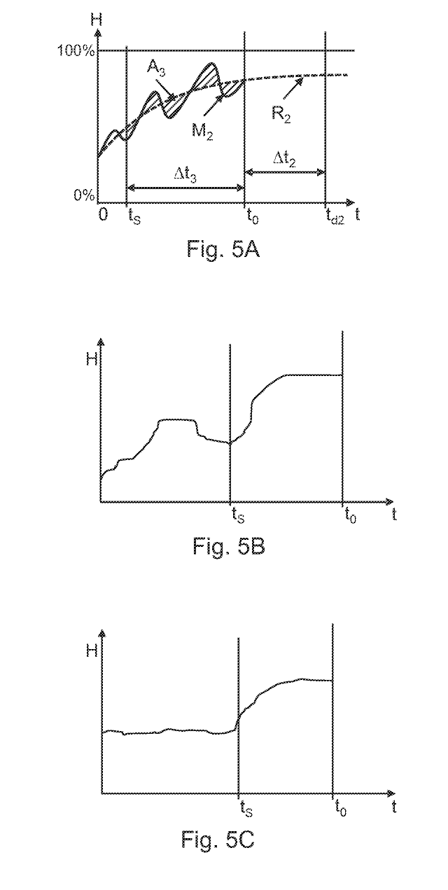

According to a further embodiment, not the entire health score curve from the moment of admission to the hospital at t=0 until the current date and time t₀ is considered for calculating the recommended moment of discharge but only a section from a starting time tₛ until t₀. In FIG. 5A the section to be considered is indicated by Δt₃.

The section of the health score curve for which the difference between the health score curve and the reference curve is computed can be determined in different ways.

In the example of the clinical support system in FIG. 5A, the instructions cause the processor to perform the steps of finding local maxima of the health score curve, finding local minima of the health score curve adjacent to the local maxima and finding a pair of local maximum and local minimum of the health score curve with an amplitude above a threshold. In this example, local maxima below a threshold are filtered out, e.g., the first maximum had a health score lower than H=50% and is not considered in the computation.

The reference curve is obtained by fitting a curve to this section of the health score curve. The curve allows to extrapolate the recovery of the patient into the future and is used to calculate the difference between health score curve and reference curve. From the chosen reference curve, the moment in time t_{d0} (see FIG. 4B) is known when the reference curve has saturated enough to send a patient home safely. From the reference curve, the estimated moment of discharge t_{d0} can be calculated as a function of the health score H, i.e. as t_{d0}(H).

In a next step, the area A₃ is calculated as described above, however, only for the section Δt₃.

In a next step, the estimated moment of discharge t_{d0}(H) from the fitted curve is combined with a function q(A) that accounts for the difference A₃ between health score curve M₂ and reference curve R₂. The recommended moment of discharge is, for example, calculated in a multiplicative way t_{d2}(H,A)=t_{d0}(H)q(A), wherein q(A) is a scaling factor that scales the time t_{d0} depending on A₃. Alternatively, the recommended moment of discharge is calculated in an additive way t_{d2}(H,A)=t_{d0}(H)+q(A). In the additive calculation, the quantity q(A) represents the time difference Δt_{d2} between the predicted moment of discharge t_{d0} and the recommended moment of discharge t_{d2} shown in FIG. 4B.

In FIG. 5B, the starting point tₛ is determined from a local minimum of the health score curve.

In FIG. 5C, the starting point tₛ is determined by evaluating the slope of the health score curve. In this example, the starting point tₛ is defined as the point when the slope of the health score curve surpasses a threshold value.

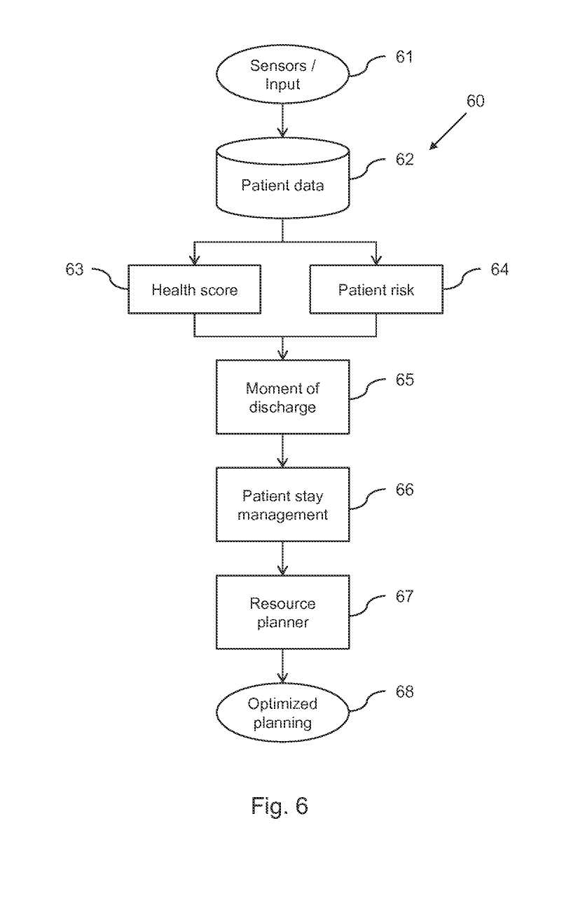

FIG. 6 illustrates the framework 60 in which the clinical support system can be used. The patient data in a database 62 represents the information source that contains data from the patient, for example, a personalized health record or any other information from a medical information system. An input to the database 62 is provided by sensors 61. The patient data 62 originates from physical measurements taken from sensors 61 connected to the patient, for example, through a Philips Intellivue patient monitor. Alternatively, the input to the patient database 62 is provided from samples from the patient such as, for example, blood, saliva, or urine.

In addition to patient data from the patient for whom a recommended moment of discharge is to be computed, the database 62 can also comprise patient data from other patients that has also been acquired by sensors or measurements 61. The patient data from further patients can be used for comparison and to refine the shape of the reference curve that is obtained for the individual patient.

In a next step 63 a health score curve of the patient is obtained based on the patient data 62. The health score typically indicates the patient's status as a percentage ranging from 0 (patient is dead) to 100% (patient is perfectly fit). The health scores can be disease-specific. For example, different weighting factors may be applied to data elements of the patient data 62. Alternatively, the health score is a relative value where 100% corresponds to the average health score of a peer group. Further alternatively the health score is an absolute number.

Optionally, step 64 comprises a patient risk estimation. This component contains a model of patient risk determined from the given patient data. This can be a fully automated risk model that has been developed using statistical or machine learning techniques but can also be a manual or hybrid model in which also manually entered risk factors by the patient or medical personnel, are taken into account. The data can range from imaging data to laboratory values and from signs to symptoms to social characteristics. Typically, these risk models indicate the risk of readmission or mortality as percentage based upon a mathematical expression that combines several data elements, for example as a linear combination or rule-based derivation. Optionally, the considerations that take the patient risk into account are part of the health score determination in 63. In other words, the health score as used in the context of the present invention, relates to the current status of the patient but can also comprise risk factors of the patient. For example a patient that has a good health status today but has a significant risk of an adverse event in the future may have a lowered health score already today.

The next module 65 computes the recommended moment of discharge from the medical facility based on the difference between the health score curve and a reference curve. For this purpose, a reference curve is derived as explained above. The recommended moment of discharge of the patient is provided to a patient stay management module 66. The patient stay management module takes the recommended moment of discharge of the patient into account and optionally also the recommended moments of discharge of other patients. The information is integrated into an overview of patients that are currently hospitalized with their recommended moments of discharge.

The resource planner 67 takes the recommended discharge moment of all patients, their moments of admission and derives the current “degree of completion”. For example, if a patient is halfway into his projected length-of-stay, then his degree of completion is 50%. The resource planner 67 can combine the recommended moment of discharge with historic information on the resource requirements during different periods within the length-of-stay and thereby produces a prediction of the resource utilization of all in-hospital patients. Based upon this overview, a match between available resources and predicted required resources can be made and an optimized planning 68 for the treatment of current and the admission of new patients can be created.

The teachings of this last example can be applied to a multitude of diseases and used to predict resource availability for a multitude of resources, for example bed availability for patients with chronic heart failure, CT/MRI scanner availability for oncology patients, staff availability for discharge preparation and discharge meeting. In general, the proposed system and method are applicable to any clinical and health care domain.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. A clinical support system comprising a processor and a computer-readable storage medium, wherein the computer-readable storage medium contains instructions for execution by the processor, wherein the instructions cause the processor to perform the steps of:
obtaining a health score curve over time of a patient, for whom a recommendation for a moment of discharge from a medical facility shall be provided,
obtaining a reference curve to the health score curve, wherein said reference curve indicates a patient stabilization over time,
computing a difference between the health score curve and said reference curve, and
computing a recommended moment of discharge from the medical facility based on the difference between said health score curve and said reference curve.

2. The clinical support system as claimed in claim 1, wherein the period of time until the recommended moment of discharge scales with said difference between the health score curve and the reference curve.

3. The clinical support system as claimed in claim 1, wherein the instructions further cause the processor to compute said difference between the health score curve and the reference curve by computing an area between the health score curve and the reference curve.

4. The clinical support system as claimed in claim 1, wherein the instructions further cause the processor to obtain the reference curve by fitting a curve to the health score curve.

5. The clinical support system as claimed in claim 1, wherein the instructions further cause the processor to identify a section of the health score curve and/or a section of the reference curve for which the difference between the health score curve and the reference curve is computed.

6. The clinical support system as claimed in claim 5, wherein the instructions further cause the processor to perform the steps of:
finding local maxima of the health score curve,
finding local minima of the health score curve adjacent to the local maxima, and
finding a pair of local maximum and local minimum of the health score curve with an amplitude above a threshold,
wherein said section of the health score curve and/or said section of the reference curve starts at the local maximum or local minimum of the pair of local maximum and local minimum.

7. The clinical support system as claimed in claim 5, wherein the instructions further cause the processor to perform the steps of:
computing a difference curve by subtracting a correction curve from the health score curve, and
finding zero-crossings of the difference curve,
wherein said section of the health score curve and/or said section of the reference curve starts a zero-crossing of the difference curve.

8. The clinical support system as claimed in claim 1, wherein the instructions further cause the processor to calculate a moment of saturation, when the reference curve has reached a saturation threshold, which saturation threshold indicates a moment in time when reference curve has saturated enough for patient discharge.

9. The clinical support system as claimed in claim 8, wherein the instructions further cause the processor to compute the recommended moment of discharge from the medical facility further based on said moment of saturation and/or based on an anticipated health score at said moment of saturation.

10. The clinical support system as claimed in claim 1, wherein the instructions further cause the processor to perform the steps of:
obtaining samples of patient data over time, wherein the patient data is descriptive of the patient, and
calculating health scores based on said samples of patient data.

11. The clinical support system as claimed in claim 10, wherein the instructions further cause the processor to use a clinical risk model and/or a clinical status model for computing said health scores.

12. A clinical support method comprising the steps of:
obtaining a health score curve over time of a patient, for whom a recommendation for a moment of discharge from a medical facility shall be provided,
obtaining a reference curve to the health score curve, wherein said reference curve indicates a patient stabilization over time,
computing a difference between the health score curve and said reference curve, and
computing a recommended moment of discharge from the medical facility based on the difference between said health score curve and said reference curve.

13. A computer-readable non-transitory storage medium containing instructions for execution by a processor, wherein the instructions cause the processor to perform the steps of:
obtaining a health score curve over time of a patient, for whom a recommendation for a moment of discharge from a medical facility shall be provided,
obtaining a reference curve to the health score curve, wherein said reference curve indicates a patient stabilization over time,
computing a difference between the health score curve and said reference curve, and
computing a recommended moment of discharge from the medical facility based on the difference between said health score curve and said reference curve.

14. Computer program comprising program code means for causing a computer to carry out the steps of the method as claimed in claim 12 when said computer program is carried out on the computer.

15. A clinical support system comprising:
means for obtaining a health score curve over time of a patient, for whom a recommendation for a moment of discharge from a medical facility shall be provided,
means for obtaining a reference curve to the health score curve, wherein said reference curve indicates a patient stabilization over time,
means for computing a difference between the health score curve and said reference curve, and
means for computing a recommended moment of discharge from the medical facility based on the difference between said health score curve and said reference curve.
